(19) United States
(12) Patent Application Publication
(10) Pub. No.: US 2014/0287271 A1
(43) Pub. Date: Sep. 25, 2014

(54) MAGNETIC RECORDING MEDIUM

(71) Applicant: FUJIFILM Corporation, Tokyo (JP)

(72) Inventor: Masahide SATO, Kanagawa (JP)

(73) Assignee: FUJIFILM Corporation, Tokyo (JP)

(21) Appl. No.: 14/222,119

(22) Filed: Mar. 21, 2014

(30) Foreign Application Priority Data
Mar. 22, 2013 (JP) 2013-059824
Mar. 19, 2014 (JP) 2014-056839

(51) Int. Cl. G11B 5/708; G11B 5/70

(52) U.S. Cl. CPC G11B 5/708; G11B 5/7013
USPC 428/843.1; 428/842; 428/844

(57) ABSTRACT

The magnetic recording medium comprises protrusions on a surface of a magnetic layer such that when protrusions of equal to or more than 8 nm in height as measured by AFM on the surface of the magnetic layer are divided into protrusions A formed of a spherical material and protrusions B formed of a non-spherical material, a value a, obtained by adding three times a standard deviation σ of heights of protrusions A to an average value of the heights of protrusions A, a value b, obtained by adding three times a standard deviation σ of heights of protrusions B to an average value of the heights of protrusions B, and a difference c, obtained by subtracting b from a, are calculated, conditions 13 nm≦a≦25 nm, 13 nm≦b≦25 nm, and 0.0 nm≦c≦10 nm are satisfied.

### CROSS-REFERENCE TO RELATED APPLICATIONS

This application claims the benefit of priority under 35 USC 119 to Japanese Patent Application No. 2013-059824 filed on Mar. 22, 2013 and Japanese Patent Application No. 2014-056839 filed on Mar. 19, 2014, which are expressly incorporated herein by reference in their entirety.

### BACKGROUND OF THE INVENTION

1. Field of the Invention

The present invention relates to a magnetic recording medium. More particularly, the present invention relates to a magnetic recording medium capable of affording good electromagnetic characteristics and running durability.

2. Discussion of the Background

To achieve higher recording densities and higher transmission rates, dispersing the fine particle magnetic material to a high degree and increasing the smoothness of the surface of the magnetic layer are effective in addition to employing fine particle magnetic material.

In addition, on the recording and reproducing device side, progress is being made in increasing the sensitivity of the reproduction head. In recent years, giant magnetoresistive reproduction heads (GMR heads) of higher sensitivity have been proposed.

However, when a reproduction head is made highly sensitive, noise also ends up being detected with high sensitivity. To reduce the noise from the magnetic recording medium side, as set forth above, it is effective to employ fine particle magnetic material and increase the smoothness of the surface of the magnetic layer. However, the more the smoothness of the surface of the magnetic layer is increased, the greater the friction coefficient during sliding of the medium against the reproduction head, ultimately compromising running durability.

One effective way to inhibit an increase in the friction coefficient (improve functional characteristics) is to reduce the contact surface area during sliding of the medium against the head by forming protrusions on the surface of the magnetic layer. Carbon black has conventionally been employed as a protrusion-forming agent to form such protrusions. However, because carbon black is a nonmagnetic material, the fill rate of magnetic material in the magnetic layer necessarily decreases as the amount of carbon black that is added to enhance friction characteristics is increased. This may invite a drop in reproduction output. Generally, there is a tradeoff between electromagnetic characteristics and frictional characteristics and the quantity of carbon black that is added is determined by balancing the two.

Another factor that diminishes running durability is the depositing of debris from the magnetic layer on the head and sliding members. In a magnetic recording medium, particularly a magnetic recording medium in the form of a tape, debris from the magnetic layer tends to adhere to the head and sliding members during drive running. Accordingly, to remove the material adhering to the head and sliding members, an abrasive is generally added to the magnetic layer to impart abrasiveness to the medium itself. However, since the abrasive for imparting abrasiveness is also a nonmagnetic material, the addition of an excessive quantity may decrease the fill rate of magnetic material in the magnetic layer, inviting a decrease in reproduction output. Further, the head may also end up being worn down, sometimes shortening the service life of the head. That is, there is a tradeoff between abrasiveness and the life of the head. The size and type of abrasive is selected so as to achieve a balance between the two.

As set forth above, there are tradeoffs between electromagnetic characteristics and frictional characteristics and between abrasiveness and head life.

Conventionally, in attempting to solve the above, specifying the protrusion distribution over the entire magnetic surface as measured by an atomic force microscope (for example, see Japanese Unexamined Patent Publication (KOKAI) No. 2009-087467 or English language family member US2009/087689A1); specifying the number of protrusions of abrasive per unit surface area of the magnetic layer to clarify the role of protrusions in the form of a protrusion-forming agent and abrasive (see Japanese Unexamined Patent Publication (KOKAI) Heisei No. 3-40217 or English language family member U.S. Pat. No. 5,057,364); specifying the average protrusion height of the abrasive (see Japanese Unexamined Patent Publication (KOKAI) Heisei No. 6-52541 or English language family member U.S. Pat. No. 5,512,350); specifying the number of protrusion-forming agents and abrasive per unit surface area (see Japanese Unexamined Patent Publication (KOKAI) Heisei No. 9-128739 or English language family member U.S. Pat. No. 5,718,964); and specifying the difference in the average protrusion height of the carbon black and abrasive (see Japanese Unexamined Patent Publication (KOKAI) No. 2010-231843 or English language family members US2010/246073A1 and U.S. Pat. No. 8,315,017) have been proposed, for example. The contents of the above publications are expressly incorporated herein by reference in their entirety.

### SUMMARY OF THE INVENTION

In recent years, the requirement of smoothing the surface of the magnetic layer to increase the recording density and reduce noise has been increasing in intensity. In this process, it has become difficult to realize magnetic recording media in which a balance is achieved in the tradeoff between electromagnetic characteristics and frictional characteristics and in the tradeoff between abrasiveness and head life using the techniques that have been proposed thus far.

An aspect of the present invention provides for a magnetic recording medium that moves away from tradeoffs such as the above, and is capable of exhibiting good electromagnetic characteristics, frictional characteristics, and abrasive characteristics while reducing head abrasion.

The present inventor conducted extensive research. As a result, he was able to make the following discoveries relative to the past.

The above publications, for example, provide various proposals with regard to the protrusions on the surface of the magnetic layer. Among these proposals, what has attracted attention is the average height of the protrusions on the surface of the magnetic layer (for example, see Japanese Unexamined Patent Publication (KOKAI) Heisei No. 6-52541 and Japanese Unexamined Patent Publication (KOKAI) No. 2010-231843). However, these protrusions vary in height. There are protrusions that exceed the average height and protrusions that fall below it. That is, there is a distribution in the height of the protrusions on the surface of the magnetic layer. The present inventor thought that the reason for the difficulty in resolving the above tradeoffs lie in that the focus has been on the average height of the protrusions, and not on the distribution of the height of the protrusions.

Accordingly, the present inventor conducted further extensive research. He developed the idea that, among the protrusions of various heights, the protrusions that determined the spacing between the magnetic recording medium and the head and affected frictional characteristics and electromagnetic characteristics, and the protrusions that affected the abrasiveness of the medium, were relatively high protrusions that primarily came into contact with the head and the sliding members. Further extensive research revealed that spherical materials primarily affected electromagnetic characteristics and frictional characteristics, and non-spherical materials primarily affected abrasiveness of the medium. He discovered that by specifying the height of relatively high protrusions among the protrusions formed by these materials and the difference in height of the relatively high protrusions among the protrusions formed by these materials, it was possible to obtain a magnetic recording medium with little head abrasion and good electromagnetic characteristics, frictional characteristics, and abrasion characteristics. The present invention was devised on that basis.

An aspect of the present invention relates to a magnetic recording medium, which comprises a magnetic layer comprising ferromagnetic powder and binder on a nonmagnetic support, and comprises protrusions on a surface of the magnetic layer such that when protrusions of equal to or more than 8 nm in height as measured by an atomic force microscope on the surface of the magnetic layer are divided into protrusions A formed of a spherical material and protrusions B formed of a non-spherical material,

a value a, obtained by adding three times a standard deviation σ of heights of protrusions A to an average value of the heights of protrusions A,

a value b, obtained by adding three times a standard deviation σ of heights of protrusions B to an average value of the heights of protrusions B,

and a difference c, obtained by subtracting b from a,

are calculated, conditions (1) to (3) below are satisfied:

13 nm≦a≦25 nm; (1)

13 nm≦b≦25 nm; and (2)

0.0 nm≦c≦10 nm. (3)

In an embodiment, the difference obtained by subtracting the number of protrusions B per unit surface from the number of protrusions A per unit surface area ranges from −0.1 protrusions/μm² to 1.5 protrusions/μ².

In an embodiment, the spherical material is comprised of particles with a coefficient of variation, (s/d)×100, as calculated from an average value d of particle diameters of the particles and a standard deviation s of the particle diameters, of less than 20%.

In an embodiment, the spherical material is comprised of inorganic oxide particles.

In an embodiment, the spherical material is comprised of monodisperse particles.

In an embodiment, the spherical material is comprised of silica colloidal particles.

In an embodiment, the non-spherical material is comprised of nonmagnetic particles with a Mohs hardness of equal to or greater than 8.

In an embodiment, the non-spherical material is alumina.

In an embodiment, the magnetic layer comprises an aromatic hydrocarbon compound comprising a phenolic hydroxyl group.

In an embodiment, the aromatic hydrocarbon compound is denoted by formula (1):

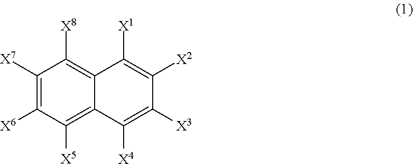

wherein, in formula (1), two from among X¹ to X⁸ denote hydroxyl groups and each of the others from among X¹ to X⁸ independently denotes a hydrogen atom or a substituent.

In an embodiment, the aromatic hydrocarbon compound comprising a phenolic hydroxyl group is selected from the group consisting of dihydroxynaphthalene and derivatives thereof.

An aspect of the present invention can provide a magnetic recording medium affording good electromagnetic characteristics, frictional characteristics, and abrasion characteristics while causing little head abrasion. An aspect of the present invention can also provide a magnetic recording medium affording good suitability to surface treatment and good running durability.

Other exemplary embodiments and advantages of the present invention may be ascertained by reviewing the present disclosure.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description making apparent to those skilled in the art how several forms of the present invention may be embodied in practice.

An aspect of the present invention relates to a magnetic recording medium, which comprises a magnetic layer comprising ferromagnetic powder and binder on a nonmagnetic support, and comprises protrusions on a surface of the magnetic layer such that when protrusions of equal to or more than 8 nm in height as measured by an atomic force microscope on the surface of the magnetic layer are divided into protrusions A formed of a spherical material and protrusions B formed of a non-spherical material,

a value a, obtained by adding three times a standard deviation σ of heights of protrusions A to an average value of the heights (average height) of protrusions A,

a value b, obtained by adding three times a standard deviation σ of heights of protrusions B to an average value of the heights (average height) of protrusions B,

and a difference c, obtained by subtracting b from a,

are calculated, conditions (1) to (3) below are satisfied:

13 nm≦a≦25 nm; (1)

13 nm≦b≦25 nm; and (2)

0.0 nm≦c≦10 nm. (3)

The magnetic recording medium of an aspect of the present invention will be described in greater detail below.

An aspect of the present invention specifies the height of protrusions by function and specifies the height of those protrusions that are relatively high among the protrusions present on the surface of a magnetic recording medium. Specifically, the distribution of protrusions that are formed of spherical material and primarily determine the spacing between the magnetic recording medium and the head, as well as affecting electromagnetic characteristics and frictional characteristics, and the distribution of protrusions that are formed of an non-spherical material and primarily affect the abrasiveness of the medium, as well as affecting head life and running durability, are specified.

In this context, the term “spherical” means a sphericity falling with a range of 1.0 to 1.3. Accordingly, a material with a sphericity exceeding 1.3 is defined as a “non-spherical material.” Spherical material can be a so-called protrusion-forming agent. When the role thereof is taken into account, it is good for the surface area coming into contact with the head to be as small as possible. Thus, it is preferred that the contact between the head and the protrusion-forming agent can be approximately point contact. When the sphericity of the protrusion-forming agent is low, abrasion of the protrusion-forming agent by sliding against the head is pronounced, and it sometimes becomes difficult to achieve a long-term friction characteristic-enhancing effect. Additionally, the formation of high protrusions by particles having highly anisotropic shapes sometimes becomes a factor in spacing. Accordingly, in order that the contact between the protrusion-forming agent and the head more closely approaches point contact, the spacing loss is reduced and it becomes possible to achieve good frictional characteristics over an extended period, spherical material is employed as the protrusion-forming agent in the present invention.

By contrast, the non-spherical material is a so-called abrasive that desirably has as low sphericity and as angular a shape as possible to remove material adhering to the head and sliding members. Accordingly, in an aspect of the present invention, in addition to protrusions formed of spherical material, protrusions formed of a non-spherical material are also provided on the surface of the magnetic layer.

The value used for the “sphericity” is calculated using the photograph taken by a transmission electron microscope obtained in the measurement of the average particle size, described further below, by taking the longest diameter (major axis diameter) and the shortest diameter (minor axis diameter) of the individual particles, calculating the average value of the particles measured, and employing the equation given below:

Sphericity=(average value of major axis diameter)/(average value of minor axis diameter)

The sphericity of the spherical material falls within a range of 1.0 to 1.3, as stated above. From the perspectives of inhibiting variation in the protrusion distribution, reducing abrasiveness, and extending head life, it desirably falls within a range of 1.0 to 1.2, preferably within a range of 1.0 to 1.1. When the particles are perfect spheres (true circles on the particle photograph), the sphericity that is calculated with the above equation becomes 1.0. A spherical material with a sphericity of 1.0 is an ideal protrusion-forming agent.

(Definition of Protrusion)

The term “protrusion” as employed in the present invention is defined as a protrusion with a height of equal to or more than 8 nm from the reference plane, where the reference plane is determined as the plane such that the volume of convex components equals the volume of concave components in the field of view as measured by an atomic force microscope. The reason why it is defined as equal to or more than 8 nm from the reference plane is that a portion that was lower than 8 nm would end up including the base material of the magnetic layer itself. The threshold value of equal to more than 8 nm from the reference plane is set to pick up just protrusions formed of the spherical material and non-spherical material. Protrusions of a height exceeding 50 nm from the reference plane are not average protrusions of the magnetic recording medium. The possibility of their being due to adhesion of irregular dust and the like is high. Protrusions formed of spherical material and non-spherical material are normally not contained among protrusions with a height from the reference plane of more than 50 nm. Accordingly, during analysis, a threshold of equal to or less than 50 nm is set and protrusions with a height of 8 to 50 nm from the reference plane are analyzed.

The average value of particle diameter (average particle diameter) of most of the particles employed as the protrusion-forming agent and the abrasive is about 50 to 200 nm. Accordingly, the range of the field of view of an atomic force microscope should be narrowed to a range where these protrusion components can be adequately measured. From the above perspective, the analysis of protrusions is desirably conducted with a range of field of view of 1 μm to 10 μm square.

(Method of Measuring the Protrusion Distribution)

To separate the protrusions defined as set forth above into those derived from spherical material and those derived from non-spherical material, some sort of method is used to obtain a chemical component map of a surface precisely identical to the magnetic surface measured by an atomic force microscope. For example, for a magnetic recording medium comprising a spherical material in the form of silica colloidal particles and a non-spherical material in the form of aluminum oxide (α-alumina), a component map can be obtained by a scanning electron microscope (SEM). In this process, to observe by SEM a spot identical to the magnetic surface measured by an atomic force microscope, in the course of conducting measurement by an atomic force microscope, it suffices to take such measures as scoring marks with a hard cantilever (such as one made of single crystal silicon). Mapping of the chemical components on the magnetic surface is not limited to the above-mentioned SEM. It is also possible to employ energy dispersive X-ray spectrometry (EDS), auger electron spectroscopy (AES), or the like. There is no limit to these methods so long as a chemical component map can be measured and the distinction between protrusions that is targeted in an aspect of the present invention can be made.

In an aspect of the present invention, protrusions of equal to or more than 8 nm in height as measured on the surface of the magnetic layer by an atomic force microscope are categorized as protrusions A formed of spherical material and protrusions B formed of non-spherical material. The average height and standard deviation are determined for protrusions A and protrusions B. The value obtained by adding three times the value of the standard deviation σ to the average height Avg., “Avg.+3σ”, is then employed as a representative value for each of protrusions A and B. The representative value represents the height of the relatively high protrusions in the protrusion distribution containing protrusions of various heights. The value a, calculated by adding three times the value of the standard deviation σ to the average height of protrusions A, the value b, calculated by adding three times the value of the standard deviation σ to the average height of protrusions B, and the difference c, obtained by subtracting b from a, are calculated.

The number of individual protrusions of a certain degree is required to perform the above statistical and mathematical processing. The present inventor discovered that it sufficed to extract at least 50 or more protrusions. Even when the number of protrusions was increased beyond that, the value of “Avg.+3σ” would not change greatly. That is, within a range of equal to or more than 50 protrusions, the value of “Avg.+3σ” was not greatly dependent on the number of protrusions. Accordingly, in the present invention, a, b, and c are values that are obtained by measuring equal to or more than 50 protrusions each for protrusions A and protrusions B. The number of protrusions measured is desirably equal to or more than 100. For example, it is about 100 to 500.

As set forth above, for protrusions A formed of spherical material, the “Avg.+3σ” is defined as a. a can determine the spacing between the surface of the magnetic recording medium and the magnetic head. The larger a becomes, the greater the spacing, the more the electromagnetic characteristics decrease, and generally, a drop in output called “spacing loss” occurs. Conversely, in terms of the frictional characteristic with the head, the wider the spacing the greater the advantage, and the lower the friction coefficient becomes. From the perspective of the electromagnetic characteristics, the lower limit of a is equal to or more than 13 nm. From the perspective of frictional characteristics with the head, the upper limit is equal to or lower than 25 nm. Thus, in an aspect of the present invention, a satisfies condition (1):

13 nm≦a≦25 nm.

From the perspective of achieving a good balance between electromagnetic characteristics and frictional characteristics, condition (1) is desirably:

15 nm≦a≦23 nm

and preferably:

16 nm≦a≦21 nm.

For protrusions B formed of non-spherical material, the “Avg.+3σ” is defined as b. b can affect the abrasive characteristics of the magnetic recording medium itself. In a magnetic recording medium, rubbing with sliding members generally generates shavings (debris) from the magnetic surface while running within a drive. When this debris adheres to the head, it becomes a major factor in clogging elements that read the recorded signal and increasing the error rate. To remove such debris that has adhered to the head, it is better to impart abrasive characteristics to the magnetic recording medium itself. In this context, when b is excessively low, capacity to remove the debris caused by repeated running is inadequate. However, when the abrasiveness is excessive, the head itself is worn down and the life of the head shortens. Accordingly, from the perspective of imparting good abrasive characteristics to the medium, the lower limit of b is set to equal to or more than 13 nm. From the perspective of head life, the upper limit is set to equal to or lower than 25 nm.

Accordingly, b satisfies condition (2) in an aspect of the present invention:

13 nm≦b≦25 nm.

From the perspective of achieving a good balance between abrasive characteristics and head life, condition (2) is desirably:

14 nm≦b≦20 nm

and preferably:

15 nm≦b≦19 nm.

The level of abrasion by the AlFeSil alloy (an alloy of 5.4 weight percent aluminum, 85 weight percent iron, 9.6 weight percent silicon) that is normally used as a head material can be given as a means of evaluating the abrasive characteristics of a magnetic recording medium (for example, see Japanese Unexamined Patent Publication (KOKAI) Heisei No. 11-86265, which is expressly incorporated herein by reference in its entirety). In an aspect of the present invention, as well, this level of abrasion can be used as an indicator of the abrasive characteristic of a magnetic recording medium. The term “AlFeSil abrasion level” refers to preparing a square material of AlFeSil alloy, causing the magnetic surface to lap one edge of the square material of AlFeSil alloy with the tape perpendicular in the longitudinal direction, making several passes of a certain distance, and adopting the length of the flat portion produced by abrasion as the abrasive characteristic.

As one general method of measuring the AlFeSil abrasion level, the lapping angle between the square material of AlFeSil alloy and the tape is set to 12°, 50 passes of 580 m per pass are made under conditions of a line speed of 180 m/min and a tension of 1 N, and the length of the abrasion surface is measured under a microscope. Although the optimal value of the length of the abrasion surface of the abrasion surface measured in this manner will vary with the system adopted and the material and shape of the head, the optimal value obtained will generally be 20 μm to 60 μm, desirably 25 μm to 55 μm, and preferably, 30 μm to 50 μm. When the AlFeSil abrasion level is equal to or more than 20 μm, the debris that is generated by repeated running can be adequately removed. At equal to or lower than 60 μm, it is possible to prevent a shortening of the head life.

In the present invention, the difference “a−b” between a and b above is defined as c. c is the difference in height between relatively high protrusions formed of the so-called protrusion-forming agent and relative high protrusions formed of the so-called abrasive. The larger c is, the greater the reduction in the effect caused by the abrasive and the lower the abrasiveness of the magnetic recording medium becomes. Conversely, the smaller c is, the greater the effect of those protrusions formed of non-spherical material on abrasiveness and the more the above abrasion level increases. Accordingly, from the perspective of suitably controlling the abrasive characteristic in an aspect of the present invention, c is set to satisfy condition (3):

0.0 nm≦c≦10 nm.

That is because the abrasiveness of the medium itself decreases and the ability to remove debris decreases when c exceeds 10 nm. Conversely, when c is a negative value, it means that the protrusions B formed of non-spherical material are higher than protrusions A formed of spherical material. In that case, the abrasion level becomes extremely high and the head life ends up being shortened. Accordingly, c is specified as satisfying condition (3) in an aspect the present invention. From the perspective of achieving a balance between long head life and abrasive characteristics, condition (3) is desirably:

1.0 nm≦c≦8.0 nm,

and preferably:

1.5 nm≦c≦7.0 nm.

Since the magnetic recording medium of an aspect the present invention satisfies conditions (1) to (3), especially conditions (2) and (3), it can exhibit suitable abrasive characteristics. This is advantageous in terms of suitability to surface treatment. This point will be described below.

One method of treating the surface of the magnetic recording medium is to rub running tape surfaces (magnetic surfaces) together (see Japanese Unexamined Patent Publication (KOKAI) No. 2007-287310, which is expressly incorporated herein by reference in its entirety). Conventional surface treatment methods that are employed in the manufacturing of magnetic recording media include blade treatment, treatment with a polishing tape, and treatment with a diamond wheel. However, in these conventional methods, spent product may be generated by the surface treatment and the amount of work required to treat the surface may change due to changes over time in the treatment materials. By contrast, the surface treatment method disclosed in the above publication does not produce spent products during surface treatment. There is also a further merit in that since fresh magnetic surfaces are continuously being rubbed together, the amount of work required for surface treatment remains constant. However, the method of surface treatment by rubbing magnetic surfaces together ends up scratching the magnetic surface when treating magnetic recording media of excessively high abrasive characteristics. A magnetic recording medium with an AlFeSil abrasion level of higher than 50 μm is known to tend to cause scratching. By contrast, in the magnetic recording medium according to an aspect of the present invention, this method of surface treatment can be applied because an AlFeSil abrasion level of equal to or less than 50 μm can be achieved.

The spherical material and non-spherical material will be described next in detail.

(Spherical Material)

The spherical material that is employed can be a material that is generally employed as a protrusion-forming agent. It can be an inorganic material or an organic material. From the perspective of achieving uniform frictional characteristics, the particle size distribution of the spherical material is desirably a monodispersion that exhibits a single peak, and not a multidispersion having multiple peaks in the distribution. From the perspective of the availability of monodisperse particles, the spherical material is desirably an inorganic material. Examples of inorganic materials are metal oxides, metal carbonates, metal sulfates, metal nitrides, metal carbides, and metal sulfides. Inorganic oxides are desirable. Examples of inorganic oxides that can be employed are α-alumina with an α conversion rate of equal to or greater than 90%, β-alumina, γ-alumina, θ-alumina, silicon dioxide, silicon carbide, chromium oxide, cerium oxide, α-iron oxide, goethite, corundum, silicon nitride, titanium carbide, titanium dioxide, tin oxide, magnesium oxide, tungsten oxide, zirconium oxide, boron nitride, zinc oxide, calcium carbonate, calcium sulfate, barium sulfate, and molybdenum disulfide, either singly or in combinations of two or more. From the perspective of the availability of monodisperse particles, silicon dioxide is desirable. As set forth further below, colloidal particles are desirably employed as the spherical material. Reference can be made to Japanese Unexamined Patent Publication (KOKAI) No. 2011-48878, which is expressly incorporated herein by reference in its entirety, for colloidal particles. Of these, from the perspective of the availability of monodisperse colloidal particles, silica colloidal particles (colloidal silica) are preferred.

The read track width on the head side has become ever narrower in recent years as the recording density has risen in the magnetic recording media employed as computer backup tapes. As a result, the demands placed on the size and the frequency (density) of the nonmagnetic material present on the surface of the magnetic layer have also become ever more stringent. Given the above, the use of conventional coarse carbon black as the protrusion-forming agent can no longer readily respond to such needs. Accordingly, to respond to the above needs, it is desirable to form the protrusions out of spherical material with a narrow particle size distribution. From the above perspective, the spherical material is desirably comprised of particles in which the variation coefficient (s/d)×100 calculated from average value (average particle diameter) d and the standard deviation s of the particle diameter is less than 20%. To achieve even better frictional characteristics and electromagnetic characteristics, the variation coefficient is desirably equal to or less than 15%, preferably equal to or less than 10%, and more preferably, equal to or less than 7%. The lower the variation coefficient is the better due to the sharper particle size distribution achieved. When the particle size distribution of the particles that are practically available is considered, the lower limit may be about 3.0%, for example.

In the present invention, the average particle diameter d of the spherical material is defined as the value obtained for equal to or more than 50, desirably equal to or more than 100, primary particles by the method described in paragraph 0015 of Japanese Unexamined Patent Publication (KOKAI) No. 2011-48878, which is expressly incorporated herein by reference in its entirety. Reference can also be made to the above paragraph for details regarding the sample powder used in measurement. Reference can also be made to paragraphs 0035-0037 of Japanese Unexamined Patent Publication (KOKAI) No. 2010-231843, which is expressly incorporated herein by reference in its entirety, for the average particle size and particle shape of other powders, such as the ferromagnetic powder, in the present invention.

As set forth above, it is desirable to form the protrusions of spherical material with a narrow particle size distribution. To achieve an even better effect by using such spherical material, it is desirable to prevent aggregation of the spherical material in the magnetic layer and to disperse it to a high degree. It is preferable for the spherical material to be present in the magnetic layer in the form of primary particles. To that end, the method of (1) employing colloidal particles as the spherical material and (2) employing spherical material that can be dispersed in the organic solvent employed in the coating material for forming the magnetic layer can be adopted. For details regarding methods (1) and (2), reference can be made to paragraphs 0022-0028 of Japanese Unexamined Patent Publication (KOKAI) No. 2011-48878.

(Non-Spherical Material)

The non-spherical material that is employed in combination with the spherical material set forth above has a sphericity exceeding 1.3, as stated above. The sphericity of the non-spherical material falls within a range of more than 1.3 and equal to or less than 2.0, for example. In order for the non-spherical material to function well as an abrasive, it is desirably a non-spherical material with a Mohs hardness of equal to or greater than 8. That is because materials with a Mohs hardness of equal to or less than 7 will sometimes deform due to contact pressure with the head. Since the maximum Mohs hardness is 10, the Mobs hardness of the non-spherical material is a maximum of 10. From the perspective of inhibiting abrasion of the head, the Mohs hardness of the non-spherical material is desirably equal to or less than 9. By contrast, the Mohs hardness of the above spherical material can be equal to or greater than 8, or equal to or lower than 7.

Examples of the non-spherical material that is employed as the abrasive in the magnetic layer are alumina (Al₂O₃), silicon carbide, boron carbide (B₄C), SiO₂, TiC, chromium oxide (Cr₂O₃), cerium oxide, zirconium oxide (ZrO₂), iron oxide, and diamond powder. Of these, alumina, silicon carbide, and diamond are desirable, and alumina is preferred. These non-spherical materials, so long as they are non-spherical, can be of any shape, such as acicular or cubic, but an non-spherical material in which a portion of the shape is angular is desirable for heightened abrasiveness.

The contents of the spherical material and the non-spherical material in the magnetic layer can be set to within ranges that can ensure electromagnetic characteristics, frictional characteristics, and abrasiveness, and are not specifically limited. The content of the spherical material is desirably 1.0 weight parts to 4.0 weight parts, preferably 1.5 weight parts to 3.5 weight parts, per 100 weight parts of ferromagnetic powder. Additionally, the content of the non-spherical material is desirably 1 weight parts to 20 weight parts, preferably 3 weight parts to 15 weight parts, and more preferably, 4 weight parts to 10 weight parts per 100 weight parts of ferromagnetic powder.

(Protrusion Density)

The protrusion density is the number of protrusions per unit surface area. As set forth above, a magnetic recording medium in which a, b, and c—which are calculated as the relation between the height of the protrusions formed of the spherical material and the protrusions formed of the non-spherical material—satisfy conditions (1) to (3) above will exhibit good electromagnetic characteristics, frictional characteristics, and abrasiveness while inhibiting head abrasion. To further enhance these various characteristics, the difference in the protrusion density of the two protrusions—(the protrusion density of the protrusions formed of the spherical material) minus (the protrusion density of the protrusions formed of the non-spherical material)—desirably falls within a range of −0.1 protrusions/μm² to 1.5 protrusions/μm². When this difference is equal to or greater than −0.1 protrusion/μm², adequate frictional characteristics can be achieved without employing carbon black, which is a coarse protrusion-forming agent. When it is equal to or less than 1.5 protrusions/μm², the electromagnetic characteristics and the error rate can be improved. The difference in the protrusion density is desirably −0.1 protrusions/μm² to 1.0 protrusion/μm², preferably falling within a range of from 0.0 protrusions/μm² to 0.70 protrusions/μm².

(Methods of Controlling a, b, c and the Like)

Above-described a, b, c, and the difference in protrusion density can be controlled by the size, particle size distribution, and quantities added of the spherical and non-spherical materials employed, the method of dispersion, the thickness of the magnetic layer and the nonmagnetic layer, the method of treating the surface of the magnetic layer, and the like. Examples of such control methods are adjustment of the deformation characteristics of the nonmagnetic support, the method of forming the nonmagnetic layer, and control of the calendering conditions described in Japanese Unexamined Patent Publication (KOKAI) No. 2010-231843, paragraph 0026. The method described in Japanese Unexamined Patent Publication (KOKAI) No. 2010-231843, paragraph 0029, can be adopted as the surface treatment method. The surface treatment method employing a diamond wheel of Japanese Unexamined Patent Publication (KOKAI) Heisei No. 5-62174, which is expressly incorporated herein by reference in its entirety, can also be adopted. For the above-stated reasons, use of the method of surface treatment by rubbing running tape surface (magnetic surfaces) together, as described in Japanese Unexamined Patent Publication (KOKAI) No. 2007-287310, is desirable. The quantities added are as set forth above.

The average particle diameter of the spherical material desirably falls within a range of 40 nm to 200 nm, preferably within a range of 100 nm to 150 nm. Spherical material with an average particle diameter of equal to or greater than 40 nm can perform well the role of forming protrusions that protrude suitably from the surface of the magnetic layer. As the size of spherical material increases, the greater the proportion of the nonmagnetic material present on the surface of the magnetic layer becomes and the more the error rate tends to increase. Thus, from the perspective of achieving a low error rate, spherical material with an average particle diameter of equal to or less than 200 nm is desirable. From the perspective of suitability to systems in which the width of the read head has been growing narrower in recent years, the use of spherical material with an average particle diameter of equal to or less than 200 nm is desirable. Additionally, from the perspectives of polishing capability, head life, and the error rate, the non-spherical material desirably has a specific surface area S_{BET} as measured by the BET method that falls within a range of 14 m²/g to 40 m²/g.

Dispersion of the spherical material is conducted as set forth above. For the non-spherical material, a dispersing agent is desirably employed to enhance dispersion of small diameter particles. Of these, aromatic hydrocarbon compounds having one or more phenolic hydroxyl groups are dispersing agents that are capable of properly maintaining the dispersion and dispersion stability of non-spherical materials of fine particles, particularly alumina fine particles, in coating materials for forming the magnetic layer. The reason for this is not entirely clear. However, the fact that aromatic hydrocarbon compounds having phenolic hydroxyl groups can adsorb to the active points on the surface of alumina is presumed to contribute to enhancing dispersion and dispersion stability. In this regard, the surface pH is known to change from one moment to the next when an alumina dispersion treatment is applied. This is thought to be because the dispersion treatment may crush the alumina powder, forming new active surface points. When the new active points adsorb together, the aggregation of alumina is promoted. By contrast, when an aromatic hydrocarbon compound having phenolic hydroxyl groups adsorbs to these active points, the aggregation can be prevented. As a result, the presumption is that it becomes possible to stably disperse alumina to a high degree.

The phenolic hydroxyl group refers to a hydroxyl group bonded directly to the aromatic ring. With regard to using an aromatic hydrocarbon compound having phenolic hydroxyl groups to prepare a coating material for forming the magnetic layer of a particulate magnetic recording medium, Japanese Unexamined Patent Publication (KOKAI) Heisei No. 3-292617, which is expressly incorporated herein by reference in its entirety, proposes dihydroxynaphthalene as a component that can prevent the deterioration due to oxidation of the ferromagnetic metal particles used in magnetic recording. However, the fact that aromatic hydrocarbon compounds having phenolic hydroxyl groups, such as dihydroxynaphthalene, are components that are capable of enhancing the dispersion and dispersion stability of alumina has only recently been discovered.

The aromatic ring that is contained in the aromatic hydrocarbon compound having phenolic hydroxyl groups can be monocyclic or polycyclic in structure, as well as a condensed ring. From the perspective of enhancing the dispersion and dispersion stability of aluminum, an aromatic hydrocarbon compound comprising a benzene ring or a naphthalene ring is desirable. The aromatic hydrocarbon compound can comprise one or more substituents in addition to phenolic hydroxyl groups. From the perspective of the availability of the compound and the like, examples of the substituents other than phenolic hydroxyl groups are halogen atoms, alkyl groups, alkoxy groups, amino groups, acyl groups, nitro groups, nitroso groups, and hydroxyalkyl groups. For compounds having one or more substituents in addition to phenolic hydroxyl groups, those having substituents exhibiting an electron-donating property with a Hammett substituent constant of equal to or lower than 0.4 tend to be advantageous to the dispersion of alumina. From the above perspective, examples of desirable substituents are those with the electron-donating property of a halogen atom or better, more specifically halogen atoms, alkyl groups, alkoxy groups, amino groups, and hydroxyalkyl groups.

The number of phenolic hydroxyl groups contained in the aromatic hydrocarbon compound can be one, two, three or more. When the aromatic ring of the aromatic hydrocarbon compound is a naphthalene ring, two or more phenolic hydroxyl groups are desirably contained, with two being preferred. That is, the compound denoted by formula (1) is desirable as the aromatic hydrocarbon compound comprising an aromatic ring in the form of a naphthalene ring.

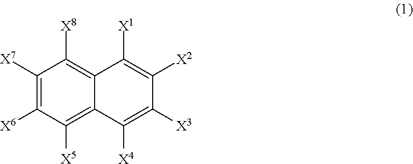

(In formula (1), two from among X¹ to X⁸ denote hydroxyl groups and each of the others from among X¹ to X⁸ independently denotes a hydrogen atom or a substituent.)

The compound denoted by formula (1) is not specifically limited to two hydroxyl group (phenolic hydroxyl group) substitution positions.

In the compound denoted by formula (1), two from among X¹ to X⁸ denote hydroxyl groups (phenolic hydroxyl groups) and each of the others independently denotes a hydrogen atom or a substituent. Of X¹ to X⁸, the portions other than the two hydroxyl groups can all be hydrogen atoms, or some or all of them can be substituents. The substituents set forth above are examples of these substituents. The substituents in addition to the two hydroxyl groups can include phenolic hydroxyl groups, but from the perspectives of enhancing stability and dispersion stability, they are desirably not phenolic hydroxyl groups. That is, the compound denoted by formula (1) is desirably a dihydroxynaphthalene or a derivative thereof. Among these, it is desirably 2,3-dihydroxynaphthalene or a derivative thereof. Examples of substituents that are desirable as the substituents denoted by X¹ to X⁸ are substituents selected from the group consisting of halogen atoms (such as chlorine atoms and bromine atoms), amino groups, alkyl groups with 1 to 6 (desirably 1 to 4) carbon atoms, methoxy groups, ethoxy groups, acyl groups, nitro groups, nitroso groups, and —CH₂OH groups

Additionally, aromatic hydrocarbon compounds comprising an aromatic group in the form of a benzene group desirably comprise one or more phenolic hydroxyl group, preferably one or two. Such aromatic hydrocarbon compounds are denoted by formula (2) below.

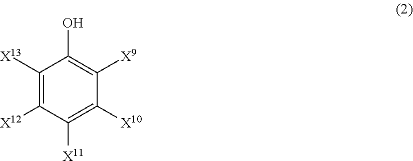

(In formula (2), each of X⁹ to X¹³ independently denotes a hydrogen atom or a substituent.)

X⁹ to X¹³ in formula (2) can all be hydrogen atoms, or some or all of them can be substituents. Examples of substituents are phenolic hydroxyl groups and the above substituents. Examples of desirable substituents are those selected from the group consisting of hydroxyl groups, carboxyl groups, and alkyl groups having 1 to 6 (desirably 1 to 4) carbon atoms.

Specific examples of desirable aromatic hydrocarbon compounds denoted by formula (2) are phenols, hydroxylbenzoic acids, and their derivatives.

A single aromatic hydrocarbon compound can be employed as a dispersing agent, or a combination of two or more can be employed. Each of these aromatic hydrocarbon compounds can be synthesized by a known method or is available as a commercial product.

To control dispersion of the spherical material and non-spherical material, it is desirable to disperse each material separately from the ferromagnetic powder. More specifically, such separate dispersion can be the method of preparing a coating material for the magnetic layer by means of a process whereby a spherical material liquid containing spherical material and solvent, non-spherical material liquid containing spherical material and solvent, and a magnetic liquid containing ferromagnetic powder, solvent, and binder are each separately prepared and then combined. After separately dispersing the various components in this manner, they are mixed together.

Reference can be made to Japanese Unexamined Patent Publication (KOKAI) No. 2011-48878, as set forth above, for separate dispersion of the spherical material.

When separately dispersing an non-spherical material liquid, the solvent employed to prepare the non-spherical material liquid is not specifically limited. When employing the above dispersing agent, it is desirable to employ one that is capable of dissolving the dispersing agent well. From the above perspective, organic solvents are desirable, among which ketone solvents are preferred. From the perspective that ketone solvents are widely employed as solvents in coating materials for forming particulate magnetic recording media, such solvents are suited to preparation of the non-spherical material. Specific examples of ketone solvents are acetone, methyl ethyl ketone, methyl isobutyl ketone, and cyclohexanone. However, in addition to ketone solvents, it is also possible to employ methanol, ethanol, isopropanol, toluene, xylene, ethyl benzene, ethyl formate, ethyl acetate, butyl acetate, dioxane, tetrahydrofuran, dimethyl formamide, and the like. The above dispersing agent is poorly soluble in water, so the use of water alone as the solvent is undesirable.

The non-spherical material liquid comprises a non-spherical material, solvent, and desirably the above dispersing agent. It also desirably comprises a resin component capable of functioning as a binder in particulate magnetic recording media. That is because coating the surface of the abrasive with a binder component can further enhance the dispersion and dispersion stability of the non-spherical material. From the above perspective, the use of a resin component that can adsorb well to the surface of the non-spherical material, specifically, the use of a resin component comprising a functional group (polar group) with polarity serving as an adsorption point to the surface of the non-spherical material, is desirable. Examples of the polar group are sulfo groups, phosphoric acid groups, hydroxy groups, carboxyl groups, and salts thereof. Sulfo groups and salts thereof, which have great adsorptive strength, are desirable. To further enhance dispersion and dispersion stability, the number of polar groups in the resin component is desirably 50 meq/kg to 400 meq/kg, preferably 60 meq/kg to 330 meq/kg.

Various resin components, such as polyurethane resins and vinyl chloride resins, can be employed as binders in a particulate magnetic recording medium. Of these, from the perspective of the dispersion and dispersion stability of the non-spherical material, the use of a polyurethane resin is desirable. Among the polyurethane resins, a polyether polyurethane or polyester polyurethane resin can be suitably employed. From the perspective of the good solubility of polyurethane resins in the suitable ketone solvents set forth above, they are desirable resin components.

The non-spherical material liquid can be prepared by simultaneously or sequentially admixing and dispersing the above components. For example, glass beads can be employed in dispersion. In addition to glass beads, a high specific gravity dispersion medium such as zirconia beads, titania beads, steel beads, or alumina beads is also suitable. It is possible to intensify the dispersion conditions by means of the particle diameter and fill rate of these dispersion media. A known dispersion apparatus can be employed. When employing the above dispersing agent, the use of proportions of 2 weight parts to 20 weight parts of dispersing agent, 150 weight parts to 970 weight parts of solvent, and 5 weight parts to 30 weight parts of resin component per 100 weight parts of non-spherical material is desirable to enhance the dispersion and dispersion stability of the non-spherical material.

Additionally, reference can be made to Japanese Unexamined Patent Publication (KOKAI) No. 2010-231843, paragraphs 0034 to 0045, for details regarding the magnetic layer in the magnetic recording medium of an aspect of the present invention.

In the magnetic recording medium of an aspect of the present invention, a nonmagnetic layer containing nonmagnetic powder and binder can be present between the nonmagnetic support and the magnetic layer. Reference can be made to Japanese Unexamined Patent Publication (KOKAI) No. 2010-231843, paragraphs 0046 to 0049, for details regarding the nonmagnetic layer. The nonmagnetic powder described in Japanese Unexamined Patent Publication (KOKAI) No. 2010-231843, paragraph 0046, can be employed in combination with carbon black as the nonmagnetic powder contained in the nonmagnetic layer. It is also possible to employ just carbon black as the nonmagnetic powder. When the nonmagnetic layer is equal to or less than 0.2 μm in thickness, for example, the content of carbon black in the nonmagnetic layer is desirably increased.

Reference can be made to Japanese Unexamined Patent Publication (KOKAI) No. 2010-231843, paragraphs 0050 to 0054, for details regarding binders that can be employed in the nonmagnetic layer. The binders that are desirable when the non-spherical material is separately dispersed are as set forth above. Reference can be made to Japanese Unexamined Patent Publication (KOKAI) No. 2010-231843, paragraphs 0057 to 0059, for details regarding additives that can be employed in the magnetic layer and nonmagnetic layer, and to paragraph 0060 of the same for the nonmagnetic support.

As described in Japanese Unexamined Patent Publication (KOKAI) No. 2010-231843, paragraph 0064, a backcoat layer can also be provided.

(Layer Structure)

In the magnetic recording medium according to an aspect of the present invention, the thickness of the nonmagnetic support is desirably 3 μm to 80 μm, preferably 3 μm to 50 μm, and more preferably, 3 μm to 10 μm.

The thickness of the magnetic layer can be optimized based on the saturation magnetization of the magnetic head employed, the length of the head gap, and the recording signal band, and is preferably 10 nm to 100 nm, and more preferably, 20 nm to 90 nm. At least one magnetic layer is sufficient. The magnetic layer may be divided into two or more layers having different magnetic characteristics, and a known configuration relating to multilayered magnetic layer may be applied.

The nonmagnetic layer is, for example, 0.05 μm to 2.0 μm, preferably 0.07 μm to 1.0 μm, and more preferably, 0.1 μm to 0.5 μm in thickness. The nonmagnetic layer of the magnetic recording medium of an aspect of the present invention can exhibit its effect so long as it is substantially nonmagnetic. It can exhibit the effect of the present invention, and can be deemed to have substantially the same structure as the magnetic recording medium according to an aspect of the present invention, for example, even when impurities are contained or a small quantity of magnetic material is intentionally incorporated. The term “substantially the same” means that the residual magnetic flux density of the nonmagnetic layer is equal to or lower than 10 mT, or the coercive force is equal to or lower than 7.96 kA/m (equal to or lower than 100 Oe), with desirably no residual magnetic flux density or coercive force being present.

(Manufacturing Method)

Reference can be made to Japanese Unexamined Patent Publication (KOKAI) No. 2010-231843, paragraphs 0065 to 0069, for details regarding the method of manufacturing the magnetic recording medium of the present invention.

The magnetic recording medium of an aspect of the present invention can exhibit good electromagnetic characteristics, frictional characteristics, and abrasive characteristics while inhibiting head abrasion. Thus, it can better respond to high-density recording. Reference can be made to Japanese Unexamined Patent Publication (KOKAI) No. 2010-231843, paragraphs 0072 and 0073, for recording and reproduction systems to which the magnetic recording medium of an aspect of the present invention can be suitably applied.

### EXAMPLES

The present invention will be described in detail below based on Examples. However, the present invention is not limited to Examples. The term “parts” given in Examples is weight parts unless specifically stated otherwise.

### Example 1

The magnetic layer-forming coating material
(Magnetic material dispersion)
Barium ferrite magnetic powder: 100 parts (Hc: 175 kA/m (2,200 Oe), average particle size: 27 nm)
Oleic acid: 2 parts
Vinyl chloride copolymer (MR-104, Zeon Corporation): 10 parts
Sulfonic acid group-comprising polyester polyurethane resin 4 parts (UR-4800 made by Toyobo)
Methyl ethyl ketone: 150 parts
Cyclohexanone: 150 parts

(Non-spherical material (abrasive) dispersion)
α-Alumina (specific surface area: 19 m²/g; sphericity: 1.4): 6 parts
Sulfonic acid group-containing polyester polyurethane resin 0.6 part (UR-4800 made by Toyobo)
2,3-Dihydroxynaphthalene: 0.6 part
Cyclohexanone: 23 parts

(Spherical material (protrusion-forming agent) dispersion A)
Colloidal silica: 2 parts (average particle diameter: 120 nm; variation coefficient: 7%; sphericity: 1.03)
Methyl ethyl ketone: 8 parts
(Lubricant solution, curing agent)
Stearic acid: 2 parts
Stearic acid amide: 0.3 part
Butyl stearate: 6 parts
Methyl ethyl ketone: 110 parts
Cyclohexanone: 110 parts
Polyisocyanate: 3 parts (Coronate L, made by Nippon Polyurethane Industry Co., Ltd.)

Nonmagnetic layer-forming coating material A
Colcothar (Bengara) 75 parts (Particle size: 0.15 μm, average acicular ratio: 7; BET surface area: 52 m²/g)
Carbon black 25 parts (Average primary particle diameter: 16 nm, DBP oil absorption capacity: 74 cm³/100 g)
Triphenyl phosphate: 3 parts
Vinyl chloride copolymer (MR-104, made by Zeon Corporation): 12 parts
Sulfonic acid group-containing polyester polyurethane resin 8 parts (UR-8401 made by Toyobo):
Methyl ethyl ketone: 370 parts
Cyclohexanone: 370 parts
Stearic acid: 1 part
Stearic acid amide: 0.3 part
Butyl stearate: 2 parts
Polyisocyanate 5 parts (Coronate L, made by Nippon Polyurethane Industry Co., Ltd.)

Backcoat layer-forming coating material
Carbon black 100 parts (Average primary particle diameter: 40 nm; DBP oil absorption capacity: 74 cm^{3/100} g)
Copper phthalocyanine: 0.3 parts
Nitrocellulose: 25 parts
Sulfonic acid group-containing polyester polyurethane resin 60 parts (UR-8401 made by Toyobo):
Polyester resin (Vylon 500, made by Toyobo): 4 parts
Alumina powder (α-alumina with specific surface area: 17 m²/g): 1 part
Polyisocyanate 15 parts (Coronate L, made by Nippon Polyurethane Industry Co., Ltd.)
Methyl ethyl ketone: 600 parts
Toluene: 600 parts

After kneading and diluting the above magnetic liquid (magnetic material dispersion) in an open kneader, it was subjected to 30 passes of dispersion treatment using zirconia (ZrO₂) beads (referred to as “Zr beads” hereinafter) 0.1 mm in particle diameter at a bead fill rate of 80%, a rotor tip peripheral speed of 10 m/s, and a single pass retention time of 2 minutes.

The abrasive liquid (non-spherical material (abrasive) dispersion) was prepared as a mixture of alumina:sulfonic acid group-containing polyester polyurethane resin (UR-4800, made by Toyobo): 2,3-dihydroxynaphthalene:cyclobexanone=100:10:10:380 (by weight). The mixture was charged to a horizontal bead mill disperser along with Zr beads having a particle diameter of 0.3 mm. The bead volume/(abrasive liquid volume+bead volume) was adjusted to 80% and bead mill dispersion processing was conducted for 120 minutes. The liquid was removed following processing and a flow ultrasonic dispersing and filtering device was employed to conduct ultrasonic wave dispersion and filtering processing.

The magnetic liquid, protrusion-forming agent liquid (spherical material (protrusion-forming agent) dispersion), abrasive liquid, and other components in the form of lubricant solution, curing agent were charged to a dissolver stirrer and stirred for 30 minutes at a peripheral speed of 10 m/s. A flow ultrasonic wave disperser was then used to implement 3 passes at a flow rate of 7.5 kg/minute. The mixture was passed through a 1 μm filter to prepare a magnetic layer-forming coating material.

The nonmagnetic layer-forming coating material was prepared by the following method.

With the exception of the lubricants (stearic acid, stearic acid amide, and butyl stearate) and polyisocyanate, the above components were kneaded and diluted in an open kneader. Subsequently, the mixture was dispersed in a horizontal bead mill disperser. Subsequently, the lubricants (stearic acid, stearic acid amide, and butyl stearate) and polyisocyanate were added and the mixture was stirred and mixed in a dissolver stirrer to prepare a nonmagnetic layer-forming coating material.

The backcoat layer-forming coating material was prepared by the following method.

With the exception of the polyisocyanate, the above components were charged to a dissolver stirrer and stirred for 30 minutes at a peripheral speed of 10 m/s. The mixture was then dispersed in a horizontal bead mill disperser. Subsequently, the polyisocyanate was added and the mixture was stirred and mixed in a dissolver stirrer to prepare a backcoat layer-forming coating material.

The nonmagnetic layer-forming coating material was coated and dried to a dry thickness of 0.1 μm on a polyethylene naphthalate support 6 μm in thickness. Subsequently, the backcoat layer-forming coating material was coated and dried to a dry thickness of 0.5 μm on the opposite side of the support. The support was rolled up and subjected to a drying treatment for 36 hours in a 70° C. dry environment.

The magnetic layer-forming coating material was then coated and dried to a dry thickness of 0.07 μm on the nonmagnetic layer following the drying treatment.

Subsequently, a surface smoothing treatment was conducted with a calender comprised of just metal rolls at a speed of 40 m/min, a linear pressure of 300 kg/cm (294 kN/m), and a temperature of 100° C. Subsequently, a drying treatment was conducted for 36 hours in a 70° C. dry environment. Following the drying treatment, the product was slit to ½ inch width.

The surface treatment of rubbing two magnetic layers together that is disclosed in Japanese Unexamined Patent Publication (KOKAI) No. 2007-287310 was then conducted. The surface treatment was carried out at a line speed of 400 m/min with moving rollers 10 mm in diameter in a 23° C., 50% RH processing environment to obtain a magnetic recording medium. The various characteristics of the magnetic recording medium thus obtained were then evaluated by the following evaluation methods.

Evaluation Methods

### (1) Method of Measuring the Protrusion Distribution and Protrusion Density

First, a score mark was made in advance on the measurement surface with a laser marker and an atomic force microscope (AFM) image was measured for the portion a certain distance (about 100 μm) from it. The range of the field of view was 7 μm square. Three or more fields of view were measured per sample so that the number of protrusions derived from the spherical material and non-spherical material was equal to or more than 50 protrusions for each. At the time, to facilitate obtaining a scanning electron microscope (SEM) image of the same spot, the cantilever was replaced with a hard cantilever (single crystal silicon) and score marks were made on the AFM. All protrusions 8 nm to 50 nm in height from the reference plane were extracted from the AFM image thus measured. An SEM image was measured at the same spot where the AFM measurement was made. The SEM image and AFM image were compared to separate the protrusions that had been extracted into spherical material (colloidal silica in Example 1) and non-spherical material (α-alumina in Example 1). By measuring three fields of view with field of view ranges of 7 μm square, 150 spherical material protrusions and 120 non-spherical material protrusions were extracted. The number of protrusions formed of spherical material and the number of protrusions formed of non-spherical material were divided by the surface area of the field of view observed to obtain protrusion densities.

The fact that equal to or more than 50 protrusions had been obtained for the spherical material and for the non-spherical material was confirmed and the average height and standard deviation were calculated. Thus, a and b, as well as the difference thereof c were obtained for the spherical material and for the non-spherical material.

### (2) Suitability to Surface Treatment

A determination was made as to whether or not the surfaces had been scratched in the course of conducting the surface treatment of rubbing magnetic layers together that is disclosed in Japanese Unexamined Patent Publication (KOKAI) No. 2007-287310. The presence or absence of scratches was determined following the surface treatment by visual observation with reflected light under a halogen lamp.

### <Evaluation Standards>

No scratching whatsoever: A
Partial scratching: B
Scratching of entire tape: C

### (3) Average Surface Roughness of Tape Surface

The average surface roughness Ra was determined over a field of view range of 40 μm square for a different portion from the portion employed in the protrusion distribution measurement of (1) above.

### (4) Abrasion Characteristics

The AlFeSil abrasion level was measured by the method set forth above.

### (5) Evaluation of Electromagnetic Characteristics

Measurements were made with a ½ inch reel tester with a fixed head. The relative head/tape speed was 4 m/s. An MIG head (gap length 0.15 μm, track width 1.0 μm) was employed for recording. The recording current was set to the optimal recording current for the individual tape. A GMR head with an element thickness of 15 nm, a shield spacing of 0.1 μm, and a read width of 1.0 μm was employed as the reproduction head. A signal was recorded at a linear recording density of (270 KFci). The reproduction signal was measured with a spectrum analyzer made by Shibasoku Corp. The ratio of the carrier signal output to the integrated noise of the full spectral band was adopted as the S/N ratio. The S/N ratio was evaluated based on the following scale.

The S/N ratio of Example 1 was adopted as 0 dB.
More than +2.0 dB over the S/N ratio of Example 1: A
0.5 dB to +2.0 dB over the S/N ratio of Example 1: B
0.0 dB to less than +0.5 dB over the S/N ratio of Example 1: C
Less than the 0 dB of the S/N ratio of Example 1: D

### (6) Evaluation of Frictional Characteristics (Sliding Properties)

The tape was lapped 1800 on a round rod of AlTiC that was 4 mm in diameter and Ra=15 nm when measured for a range of 40 μm square by AFM. A 100 g load was applied and the tape was slid 45 mm at a rate of 14 mm/s. The load during sliding at equal speed at pass 100 was detected with a load cell and the frictional coefficient was calculated based on the following equation:

Frictional coefficient=ln(measurement value (g)/100 (g))/π.

It was then evaluated on the following scale:

Frictional coefficient<0.25: A

0.25≦frictional coefficient<030: B

0.30≦frictional coefficient<0.4: C

Frictional coefficient>0.4: D

### Example 2

With the exception that six parts of 2,3-dihydroxynaphthalene were added to the magnetic material dispersion liquid of the magnetic layer-forming coating material in Example 1, a magnetic recording medium was obtained by the same method as in Example 1 and the characteristics thereof were evaluated by the methods set forth above.

### Example 3

With the exception that the barium ferrite magnetic powder was replaced with one having an average particle size of 20 nm and an He of 191 kA/m (2,400 Oe) in the magnetic material dispersion of the magnetic layer-forming coating material in Example 2, a magnetic recording medium was obtained by the same method as in Example 2 and the characteristics thereof were evaluated by the methods set forth above.

### Example 4

With the exception that the spherical material (protrusion-forming agent) in the magnetic layer-forming coating material in Example 3 was replaced with colloidal silica with a sphericity of 1.04, a variation coefficient of 8%, and an average particle diameter of 110 nm, a magnetic recording medium was obtained by the same method as in Example 3 and the characteristics thereof were evaluated by the methods set forth above.

### Example 5

With the exception that the thickness of the nonmagnetic layer was changed to 0.13 μm in Example 3, a magnetic recording medium was obtained by the same method as in Example 3 and the characteristics thereof were evaluated by the methods set forth above.

### Example 6

The spherical material (protrusion-forming agent) in the magnetic layer-forming coating material in Example 3 was replaced with colloidal silica with a sphericity of 1.02, a variation coefficient of 8%, and an average particle diameter of 150 nm. The thickness of the nonmagnetic layer was changed to 0.16 μm. With these exceptions, a magnetic recording medium was obtained by the same method as in Example 3 and the characteristics thereof were evaluated by the methods set forth above.

### Example 7

With the exception that the thickness of the nonmagnetic layer was changed to 0.20 μm in Example 6, a magnetic recording medium was obtained by the same method as in Example 6 and the characteristics thereof were evaluated by the methods set forth above.

### Example 8

With the exception that the quantity of α-alumina added to the non-spherical material (abrasive) dispersion of the magnetic layer-forming coating material in Example 7 was changed to 9 parts, a magnetic recording medium was obtained by the same method as in Example 7 and the characteristics thereof were evaluated by the methods set forth above.

### Example 9

With the exception that the thickness of the nonmagnetic layer in Example 4 was changed to 0.12 μm, a magnetic recording medium was obtained by the same method as in Example 4 and the characteristics thereof were evaluated by the methods set forth above.

### Example 10

With the exception that the quantity of α-alumina added to the non-spherical material (abrasive) dispersion of the magnetic layer-forming coating material in Example 4 was changed to 9 parts, a magnetic recording medium was obtained by the same method as in Example 4 and the characteristics thereof were evaluated by the methods set forth above.

### Example 11

With the exception that the composition of the nonmagnetic layer-forming coating material in Example 5 was changed to that indicated below, a magnetic recording medium was obtained by the same method as in Example 5 and the characteristics thereof were evaluated by the methods set forth above.
Nonmagnetic layer-forming coating material B
Carbon black: 100 parts (Average primary particle diameter: 16 nm; DBP oil absorption capacity: 74 cm³/100 g)
Copper phthalocyanine compound (Solsperse 5000, made by Lubrizol): 0.3 part
Vinyl chloride copolymer (MR-104, made by Zeon Corp.): 12 parts
Sulfonic acid group-containing polyester polyurethane resin: 8 parts (UR-8401 made by Toyobo)
Methyl ethyl ketone: 370 parts
Cyclohexanone: 370 parts
Stearic acid: 1 part
Stearic acid amide: 0.3 part
Butyl stearate: 2 parts
Polyisocyanate: 5 parts (Coronate L, made by Nippon Polyurethane Industry Co., Ltd.)

### Example 12

With the exception that the quantity of α-alumina added to the non-spherical material (abrasive) dispersion of the magnetic layer-forming coating material in Example 11 was changed to 4 parts, a magnetic recording medium was obtained by the same method as in Example 11 and the characteristics thereof were evaluated by the methods set forth above.

### Example 13

With the exception that the surface treatment method in Example 5 was changed to the method of processing the magnetic surface with a diamond wheel that is described in Japanese Unexamined Patent Publication (KOKAI) Heisei No. 5-62174, a magnetic recording medium was obtained by the same method as in Example 5 and the characteristics thereof were evaluated by the methods set forth above.

### Example 14

With the exception that the quantity of α-alumina added to the non-spherical material (abrasive) dispersion of the magnetic layer-forming coating material in Example 6 was changed to 7.5 parts and the quantity of the spherical material (protrusion-forming agent) added was changed to 1 part, a magnetic recording medium was obtained by the same method as in Example 6 and the characteristics thereof were evaluated by the methods set forth above.

### Comparative Example 1

With the exception that the protrusion-forming agent in the magnetic material dispersion of the magnetic layer-forming coating material in Example 1 was changed to a carbon black liquid (average primary particle diameter 80 nm, variation coefficient=105%, sphericity 2.5), a magnetic recording medium was obtained by the same method as in Example 1 and the characteristics thereof were evaluated by the methods set forth above.

The carbon black liquid was subjected to a liquefying treatment conducted for 30 minutes at a stirring rotational speed of 1,500 rpm in a batch-type ultrasonic wave dispersion apparatus with stirrer. The liquefied carbon black liquid was subjected to six passes of dispersion treatment in a horizontal bead mill disperser using Zr beads 0.5 mm in diameter at a bead fill rate of 80%, a rotor tip peripheral speed of 10 m/s, and a retention time of 2 minutes per pass. The liquid was stirred for 30 minutes at a peripheral speed of 10 m/s in a dissolver stirrer and then subjected to three passes of treatment in a flow ultrasonic wave disperser at a flow rate of 3 kg/minute.

### Comparative Example 2

With the exception that the quantity of protrusion-forming agent added was changed to 0.5 part in the magnetic material dispersion of the magnetic layer-forming coating material in Comparative Example 1, a magnetic recording medium was obtained by the same method as in Comparative Example 1 and the characteristics thereof were evaluated by the methods set forth above.

### Comparative Example 3

With the exception that powdered spherical silica with a sphericity of 1.3, a variation coefficient of 26.5%, and an average particle diameter of 200 nm was employed as the protrusion-forming agent in the magnetic material dispersion of the magnetic layer-forming coating material in Example 1, a magnetic recording medium was obtained by the same method as in Example 1 and the characteristics thereof were evaluated by the methods set forth above.

### Comparative Example 4

With the exceptions that the thickness of the nonmagnetic layer was changed to 0.2 μm and colloidal silica with a sphericity of 1.12, a variation coefficient of 13%, and an average particle diameter of 40 nm was employed as the protrusion-forming agent in the magnetic material dispersion of the magnetic layer-forming coating material in Example 1, a magnetic recording medium was obtained by the same method as in Example 1 and the characteristics thereof were evaluated by the methods set forth above.

### Comparative Example 5

With the exception that the composition of the non-spherical material (abrasive) dispersion in the magnetic material dispersion of the magnetic layer-forming coating material in Example 1 was changed to that indicated below, a magnetic recording medium was obtained by the same method as in Example 1 and the characteristics thereof were evaluated by the methods set forth above.
(Non-spherical material (abrasive) dispersion B)
α-alumina (specific surface area: 16 m²/g; sphericity: 1.6): 6 parts
Sulfonic acid group-containing polyester polyurethane resin: 0.6 part (UR-4800 made by Toyobo)
Cyclohexanone: 23 parts

### Comparative Example 6

With the exceptions that a powdered spherical silica with a sphericity of 1.3, a variation coefficient of 26.5%, and an average particle diameter of 200 nm was employed as the protrusion-forming agent in the magnetic material dispersion of the magnetic layer-forming coating material in Example 1 and the composition of the non-spherical material (abrasive) dispersion was changed to that indicated below, a magnetic recording medium was obtained by the same method as in Example 1 and the characteristics thereof were evaluated by the methods set forth above.
(Non-spherical material (abrasive) dispersion C)
α-alumina (specific surface area: 12 m²/g): 6 parts
Sulfonic acid group-containing polyester polyurethane resin: 0.6 part (UR-4800 made by Toyobo)
Cyclohexanone: 23 parts

### Comparative Example 7

In Example 1, the magnetic material dispersion was kneaded and dispersed in an open kneader, after which abrasive dispersion A was admixed to the magnetic material dispersion that had been processed. The mixture was then subjected to 30 passes of dispersion treatment in a horizontal bead mill disperser using zirconia (ZrO₂) beads 0.1 mm in particle diameter (referred to as “Zr beads” hereinafter) at a bead fill rate of 80%, a rotor tip peripheral speed of 10 m/s, and a single pass retention time of 2 minutes. With these exceptions, a magnetic recording medium was obtained by the same method as in Example 1 and the characteristics thereof were evaluated by the methods set forth above.

### Comparative Example 8

With the exception that colloidal silica was not added as a protrusion-forming agent in the magnetic material dispersion of the magnetic layer-forming coating material in Example 1, a magnetic recording medium was obtained by the same method as in Example 1 and the characteristics thereof were evaluated by the methods set forth above.

A summary and evaluation results of the Examples and Comparative Examples set forth above are given in the following tables.

TABLE 1

| | Average | | | | | | | | | |
|---|---|---|---|---|---|---|---|---|---|---|
| | particle | Abrasive | | Protrusion-forming agent | | | | | | |
| | diameter | Specific | | | | Average | | | Nonmagnetic layer | |
| | (nm) of | surface | | | | particle | | | Type of | |
| | ferromagnetic | area | Parts | | Parts | diameter | CV | | nonmagnetic | Thickness |
| | powder | (m²/g) | added | Type | added | (nm) | (%) | Sphericity | powder | (μm) |
| Example 1 | 27 | 19 | 6 | SiO₂ | 2 | 120 | 7 | 1.03 | Colcothar | 0.10 |
| | | | | | | | | | contained | |
| Example 2 | 27 | 19 | 6 | SiO₂ | 2 | 120 | 7 | 1.03 | Colcothar | 0.10 |
| | | | | | | | | | contained | |
| Example 3 | 20 | 19 | 6 | SiO₂ | 2 | 120 | 7 | 1.03 | Colcothar | 0.10 |
| | | | | | | | | | contained | |
| Example 4 | 20 | 19 | 6 | SiO₂ | 2 | 110 | 8 | 1.04 | Colcothar | 0.10 |
| | | | | | | | | | contained | |
| Example 5 | 20 | 19 | 6 | SiO₂ | 2 | 120 | 7 | 1.03 | Colcothar | 0.13 |
| | | | | | | | | | contained | |
| Example 6 | 20 | 19 | 6 | SiO₂ | 2 | 150 | 8 | 1.02 | Colcothar | 0.15 |
| | | | | | | | | | contained | |
| Example 7 | 20 | 19 | 6 | SiO₂ | 2 | 150 | 8 | 1.02 | Colcothar | 0.20 |
| | | | | | | | | | contained | |
| Example 8 | 20 | 19 | 9 | SiO₂ | 2 | 150 | 8 | 1.02 | Colcothar | 0.20 |
| | | | | | | | | | contained | |
| Example 9 | 20 | 19 | 6 | SiO₂ | 2 | 110 | 8 | 1.04 | Colcothar | 0.12 |
| | | | | | | | | | contained | |
| Example 10 | 20 | 19 | 9 | SiO₂ | 2 | 110 | 8 | 1.04 | Colcothar | 0.10 |
| | | | | | | | | | contained | |
| Example 11 | 20 | 19 | 6 | SiO₂ | 2 | 120 | 7 | 1.03 | Carbon | 0.13 |
| | | | | | | | | | black 100% | |
| Example 12 | 20 | 19 | 4 | SiO₂ | 2 | 120 | 7 | 1.03 | Carbon | 0.13 |
| | | | | | | | | | black 100% | |
| Example 13 | 20 | 19 | 8 | SiO₂ | 2 | 120 | 7 | 1.03 | Colcothar | 0.13 |
| | | | | | | | | | contained | |
| Example 14 | 20 | 19 | 7.5 | SiO₂ | 1 | 120 | 7 | 1.03 | Colcothar | 0.13 |
| | | | | | | | | | contained | |
| Comp. Ex. 1 | 27 | 19 | 6 | Carbon | 2 | 80 | 105 | 2.50 | Colcothar | 0.10 |
| | | | | black | | | | | contained | |
| Comp. Ex. 2 | 27 | 19 | 6 | Carbon | 0.5 | 60 | 105 | 2.50 | Colcothar | 0.10 |
| | | | | black | | | | | contained | |
| Comp. Ex. 3 | 27 | 19 | 6 | SiO₂ | 2 | 200 | 26.5 | 1.30 | Colcothar | 0.10 |
| | | | | | | | | | contained | |
| Comp. Ex. 4 | 27 | 19 | 6 | SiO₂ | 2 | 40 | 13 | 1.12 | Colcothar | 0.20 |
| | | | | | | | | | contained | |
| Comp. Ex. 5 | 27 | 16 | 9 | SiO₂ | 2 | 120 | 7 | 1.03 | Colcothar | 0.10 |
| | | | | | | | | | contained | |
| Comp. Ex. 6 | 27 | 12 | 6 | SiO₂ | 2 | 200 | 26.5 | 1.30 | Colcothar | 0.10 |
| | | | | | | | | | contained | |
| Comp. Ex. 7 | 27 | 19 | 6 | SiO₂ | 2 | 120 | 7 | 1.03 | Colcothar | 0.10 |
| | | | | | | | | | contained | |

| | | | | | | |
|---|---|---|---|---|---|---|
| Comp. Ex. 8 | 27 | 19 | 6 | None | Colcothar | 0.10 |
| | | | | | contained | |

TABLE 2

| | Protrusion distribution | | | | | | | | | |
|---|---|---|---|---|---|---|---|---|---|---|
| | Protrusion-forming agent | | | Non-spherical material(abrasive) | | | | Protrusion density (protrusions/μm²) | | |
| | Average | | | Average | | | Difference | Protrusion- | Non-spherical | |
| | height | σ | Avg. + 3σ | height | σ | Avg. + 3σ | (a − b) | forming | material | |
| | (nm) | (nm) | a (nm) | (nm) | (nm) | b (nm) | c (nm) | agent | (abrasive) | Difference |
| Example 1 | 15.0 | 2.7 | 23.1 | 12.2 | 2.6 | 20.0 | 3.1 | 1.00 | 0.78 | 0.22 |
| Example 2 | 14.9 | 2.7 | 23.0 | 12.1 | 2.6 | 19.9 | 3.1 | 0.99 | 0.79 | 0.20 |
| Example 3 | 14.8 | 2.8 | 22.5 | 12.1 | 2.5 | 19.7 | 2.8 | 0.98 | 0.80 | 0.18 |
| Example 4 | 13.7 | 2.5 | 21.2 | 12.1 | 2.7 | 20.2 | 1.0 | 1.05 | 0.83 | 0.22 |
| Example 5 | 13.4 | 2.2 | 20.0 | 12.0 | 1.8 | 17.3 | 2.7 | 1.01 | 0.35 | 0.66 |
| Example 6 | 15.5 | 2.7 | 23.6 | 10.4 | 2.0 | 16.4 | 7.2 | 1.01 | 0.39 | 0.62 |
| Example 7 | 14.0 | 2.1 | 20.3 | 9.9 | 1.7 | 15.0 | 5.3 | 0.77 | 0.38 | 0.39 |
| Example 8 | 13.7 | 2.2 | 20.4 | 9.8 | 2.1 | 16.2 | 4.2 | 0.76 | 0.82 | −0.06 |
| Example 9 | 8.7 | 2.3 | 15.6 | 9.2 | 1.9 | 14.9 | 0.7 | 0.80 | 0.37 | 0.43 |
| Example 10 | 13.8 | 2.5 | 21.3 | 12.3 | 2.9 | 21.0 | 0.3 | 1.05 | 0.90 | 0.15 |
| Example 11 | 12.5 | 2.7 | 20.5 | 10.5 | 2.8 | 16.9 | 1.6 | 0.93 | 0.48 | 0.45 |
| Example 12 | 13.3 | 3.0 | 22.3 | 10.7 | 2.1 | 17.1 | 5.2 | 0.92 | 0.41 | 0.51 |
| Example 13 | 14.9 | 2.3 | 21.8 | 12.4 | 3.0 | 21.4 | 0.4 | 0.96 | 0.28 | 0.68 |
| Example 14 | 12.4 | 3.0 | 21.4 | 9.9 | 2.0 | 15.9 | 5.5 | 0.49 | 0.65 | −0.16 |
| Comp. Ex. 1 | 19.6 | 7.5 | 42.1 | 11.4 | 1.8 | 16.8 | 25.3 | 0.07 | 0.23 | −0.16 |
| Comp. Ex. 2 | 18.1 | 7.0 | 39.0 | 10.8 | 1.7 | 16.0 | 23.0 | 0.03 | 0.22 | −0.19 |
| Comp. Ex. 3 | 16.1 | 4.3 | 29.0 | 9.5 | 2.2 | 16.1 | 12.9 | 1.11 | 0.24 | 0.87 |
| Comp. Ex. 4 | 9.1 | 1.1 | 12.5 | 9.0 | 1.9 | 14.8 | −2.3 | 0.64 | 0.36 | 0.28 |
| Comp. Ex. 5 | 13.7 | 2.4 | 20.9 | 12.4 | 3.2 | 22.0 | −1.1 | 1.45 | 1.16 | 0.30 |
| Comp. Ex. 6 | 15.0 | 2.8 | 23.4 | 13.3 | 4.0 | 25.3 | −1.9 | 1.21 | 1.23 | −0.02 |
| Comp. Ex. 7 | 14.5 | 2.7 | 22.6 | 8.4 | 0.7 | 10.4 | 12.2 | 0.99 | 0.46 | 0.53 |

| | | | | | | | | |
|---|---|---|---|---|---|---|---|---|
| Comp. Ex. 8 | None | 12.4 | 2.6 | 20.2 | None | None | 0.81 | None |

TABLE 3

| | | Average | | | |
|---|---|---|---|---|---|
| | Suitability to | surface roughness | Abrasion | | |
| | surface | of tape surface | characteristics | Electromagnetic | Frictional |
| | treatment | Ra (nm) | (μm) | characteristics | characteristics |
| Example 1 | A | 3.1 | 45 | (Evaluation standard) | A |
| Example 2 | A | 2.9 | 46 | C | A |
| Example 3 | A | 2.6 | 47 | B | A |
| Example 4 | A | 2.4 | 49 | A | B |
| Example 5 | A | 2.3 | 44 | A | A |
| Example 6 | A | 2.3 | 41 | C | A |
| Example 7 | A | 2.0 | 42 | A | A |
| Example 8 | A | 2.1 | 48 | A | A |
| Example 9 | A | 1.9 | 48 | A | C |
| Example 10 | A | 2.5 | 52 | C | A |
| Example 11 | A | 2.4 | 49 | A | A |
| Example 12 | A | 2.0 | 44 | A | A |
| Example 13 | A | 2.0 | 51 | A | A |
| Example 14 | A | 2.2 | 51 | A | B |
| Comp. Ex. 1 | A | 4.1 | 27 | D | A |
| Comp. Ex. 2 | A | 3.6 | 30 | D | A |
| Comp. Ex. 3 | A | 3.3 | 29 | D | A |
| Comp. Ex. 4 | B | 3.5 | 48 | C | D |
| Comp. Ex. 5 | C | 3.6 | 58 | D | B |
| Comp. Ex. 6 | C | 3.7 | 63 | D | B |
| Comp. Ex. 7 | A | 2.8 | 29 | A | D |
| Comp. Ex. 8 | C | 2.6 | 64 | D | D |

Evaluation Results

In Table 3, the electromagnetic characteristic or frictional characteristic evaluation results denoted as “D” did not perform adequately for practical use. The magnetic recording media of Examples 1 to 14 exhibited good frictional characteristics despite being of smooth average surface roughness. They also exhibited good electromagnetic characteristics and abrasion characteristics which were indicators of medium durability and head life.

Based on the above results, an aspect of the present invention can be confirmed to produce little head abrasion, and to enhance electromagnetic characteristics, frictional characteristics, and abrasion characteristics. In the surface treatment step of rubbing magnetic surfaces together in the Examples, an unexpected result was obtained in that no scratches were found on the magnetic surface following the surface treatment (the evaluation result for suitability to surface treatment was “A”).

The magnetic recording medium of an aspect of the present invention is useful as a magnetic recording medium for high-density recording, such as a backup tape.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A magnetic recording medium, which comprises a magnetic layer comprising ferromagnetic powder and binder on a nonmagnetic support, and comprises protrusions on a surface of the magnetic layer such that when protrusions of equal to or more than 8 nm in height as measured by an atomic force microscope on the surface of the magnetic layer are divided into protrusions A formed of a spherical material and protrusions B formed of a non-spherical material,
a value a, obtained by adding three times a standard deviation σ of heights of protrusions A to an average value of the heights of protrusions A,
a value b, obtained by adding three times a standard deviation σ of heights of protrusions B to an average value of the heights of protrusions B,
and a difference c, obtained by subtracting b from a,
are calculated, conditions (1) to (3) below are satisfied:
13 nm≦a≦25 nm; (1)
13 nm≦b≦25 nm; and (2)
0.0 nm≦c≦10 nm. (3)

2. The magnetic recording medium according to claim 1, wherein a difference obtained by subtracting the number of protrusions B per unit surface from the number of protrusions A per unit surface area ranges from −0.1 protrusions/μm² to 1.5 protrusions/μm².

3. The magnetic recording medium according to claim 1, wherein the spherical material is comprised of particles with a coefficient of variation, (s/d)×100, as calculated from an average value d of particle diameters of the particles and a standard deviation s of the particle diameters, of less than 20%.

4. The magnetic recording medium according to claim 2, wherein the spherical material is comprised of particles with a coefficient of variation, (s/d)×100, as calculated from an average value d of particle diameters of the particles and a standard deviation s of the particle diameters, of less than 20%.

5. The magnetic recording medium according to claim 1, wherein the spherical material is comprised of inorganic oxide particles.

6. The magnetic recording medium according to claim 1, wherein the spherical material is comprised of monodisperse particles.

7. The magnetic recording medium according to claim 1, wherein the spherical material is comprised of silica colloidal particles.

8. The magnetic recording medium according to claim 2, wherein the spherical material is comprised of silica colloidal particles.

9. The magnetic recording medium according to claim 3, wherein the spherical material is comprised of silica colloidal particles.

10. The magnetic recording medium according to claim 4, wherein the spherical material is comprised of silica colloidal particles.

11. The magnetic recording medium according to claim 1, wherein the non-spherical material is comprised of nonmagnetic particles with a Mohs hardness of equal to or greater than 8.

12. The magnetic recording medium according to claim 1, wherein the non-spherical material is alumina.

13. The magnetic recording medium according to claim 1, wherein the magnetic layer comprises an aromatic hydrocarbon compound comprising a phenolic hydroxyl group.

14. The magnetic recording medium according to claim 13, wherein the aromatic hydrocarbon compound is denoted by formula (1): 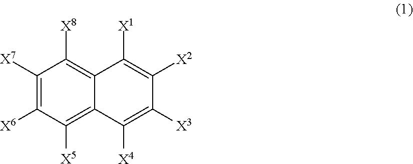
wherein, in formula (1), two from among X¹ to X⁸ denote hydroxyl groups and each of the others from among X¹ to X⁸ independently denotes a hydrogen atom or a substituent.

15. The magnetic recording medium according to claim 13, wherein the aromatic hydrocarbon compound comprising a phenolic hydroxyl group is selected from the group consisting of dihydroxynaphthalene and derivatives thereof.

16. The magnetic recording medium according to claim 14, wherein the spherical material is comprised of silica colloidal particles.

17. The magnetic recording medium according to claim 14, wherein the spherical material is comprised of silica colloidal particles and the non-spherical material is alumina.

18. The magnetic recording medium according to claim 15, wherein the spherical material is comprised of silica colloidal particles.

19. The magnetic recording medium according to claim 15, wherein the spherical material is comprised of silica colloidal particles and the non-spherical material is alumina.
